(19) United States
(12) Patent Application Publication
(10) Pub. No.: US 2017/0266800 A1
(43) Pub. Date: Sep. 21, 2017

(54) COMBINED HAMMER AND PRYER APPARATUS

(71) Applicant: Alfred Mott, Tifton, GA (US)

(72) Inventor: Alfred Mott, Tifton, GA (US)

(21) Appl. No.: 15/076,626

(22) Filed: Mar. 21, 2016

(51) Int. Cl. B25D 1/04

(52) U.S. Cl. CPC B25D 1/04

(57) ABSTRACT

A combined hammer and pryer apparatus which has a combination of hammering and prying sections comprises an arcuate body, a hammer section, and at least two pry ends. The hammer section is defined at a first end of opposing ends of the arcuate body, where the hammer section is configured to insert a fastener on one solid body or a combination of solid bodies. The pry ends are defined on the opposing ends of the arcuate body, where one of the pry ends is defined rearwardly to the hammer section, where the pry ends are configured to gradually remove a fastener from one solid body or the combination of solid bodies.

### BACKGROUND

Hammering and prying methods have been practiced for a long time in the construction of furniture and fabrication applications. Hammering is the practice of inserting a fastener between one or more sheet sections of metal or wood, while prying is the method of removing the fasteners from the hammered and fastened condition, whereby the sheet sections can be separated. Conventionally, separate tools are used for hammering as well as for prying purposes, so therefore the operator or the mechanic has to carry the tools separately in a tool kit. This way of carrying the tools separately in a tool kit makes it uncomfortable for the mechanic in terms of transportation of the tools as well as working with the tools. Even though there are numerous devices which perform multi-purpose activities, such as prying tools or hammering tools with replaceable tool end sections which enable the application of prying or hammering on fasteners of different dimensions and shapes, there is no single device or apparatus which can selectively perform both hammering and prying.

Hence, there is a long felt but unresolved need for a combined hammer and pryer apparatus for selectively performing both hammering and prying application on fasteners of any predefined dimension.

### SUMMARY OF THE INVENTION

The combined hammer and pryer apparatus comprises an arcuate body, a hammer section, and at least two pry ends. The hammer section is defined at a first end of opposing ends of the arcuate body, where the hammer section is configured to insert a fastener on one solid body or a combination of solid bodies. The pry ends are defined on the opposing ends of the arcuate body, where one of the pry ends is defined rearwardly to the hammer section, where the pry ends are configured to gradually remove a fastener from one solid body or the combination of solid bodies.

In an embodiment, a first pry end of the pry ends comprises a pry initiation end and a pry finishing end. The pry initiation end is of a generally wedge shape and is defined at a first end of the opposing ends of the arcuate body and rearwardly to the hammer section, where the pry initiation end is configured to initiate a removal of the fastener inserted between the solid bodies. In an embodiment, a first pry end of the pry ends comprise a pry finishing end of a generally hook shape and is defined at a second end of the opposing ends of the arcuate body, where the pry finishing end is configured to completely remove the fastener from between the solid bodies. In an embodiment, the combined hammer and pryer apparatus is made of a metal. In an embodiment, the combined hammer and pryer apparatus is of multiple dimensions. In an embodiment, the combined hammer and pryer apparatus is made of a metal. In an embodiment, the combined hammer and pryer apparatus further comprises a generally V shaped groove positioned on each of the pry ends on the opposing ends of the arcuate body, where the V shaped grooves are configured to assist in gradually removing the fastener from one of the solid body and the combination of solid bodies.

### BRIEF DESCRIPTION OF THE DRAWINGS

FIG. 1 exemplarily illustrates a top perspective view of the combined hammer and pryer apparatus.

FIG. 2 exemplarily illustrates a bottom perspective view of the combined hammer and pryer apparatus.

FIG. 3 exemplarily illustrates a perspective view of the combined hammer and pryer apparatus, showing the hammering action to fasten two solid bodies.

FIG. 4 exemplarily illustrates a perspective view of the combined hammer and pryer apparatus, showing prying initiation to remove the fastener between two solid bodies.

FIG. 5 exemplarily illustrates a perspective view of the combined hammer and pryer apparatus, showing prying finishing to completely remove the fastener between two solid bodies.

FIG. 6 exemplarily illustrates a perspective view of an embodiment of the combined hammer and pryer apparatus, showing V shaped grooves positioned on the opposing pry ends.

### DETAILED DESCRIPTION OF THE INVENTION

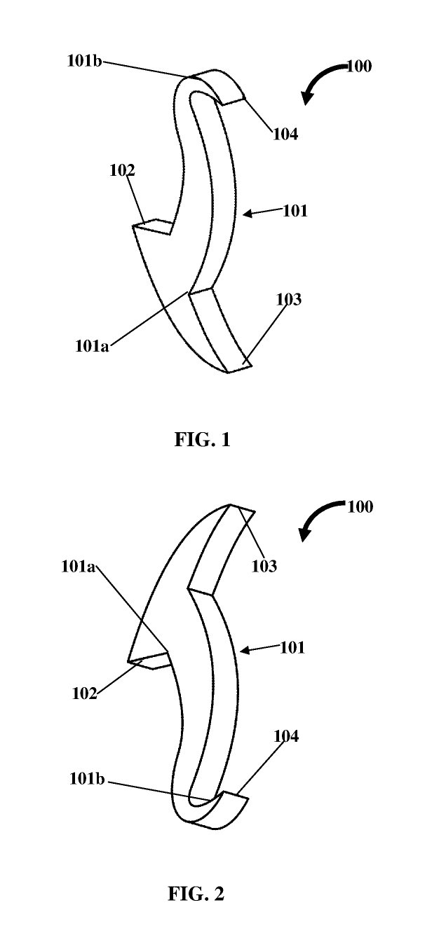

FIG. 1 exemplarily illustrates a top perspective view of the combined hammer and pryer apparatus 100, and FIG. 2 exemplarily illustrates a bottom perspective view of the combined hammer and pryer apparatus 100. Referring to FIGS. 1 and 2, the combined hammer and pryer apparatus 100 comprises an arcuate body 101 with opposing ends 101a and 101b defined for either hammering or prying operations. The combined hammer and pryer apparatus 100 is a combination device which enables a user to selectively apply during prying and hammering operations. The opposing ends 101a and 101b of the combined hammer and pryer apparatus 100 are fabricated in different shapes where one shape provides for prying operation and the other shape provides for hammering operation. The design of the combined hammer and pryer apparatus 100 enables the user to reduce time of individual prying and hammering operations as well as allows the user to transport the tools easily.

The combined hammer and pryer apparatus 100 comprises the arcuate body 101, a hammer section 102, and at least two pry ends 103 and 104. The hammer section 102 is defined at a first end 101a of opposing ends 101a and 101b of the arcuate body 101, where the hammer section 102 is configured to insert a fastener 201 on one solid body or a combination of solid bodies 202, for example, two metallic sheets or wooden planks. The fastener 201 is, for example, a screw, a nail, or a bolt. The pry ends 103 and 104 are defined on the opposing ends 101a and 101b of the arcuate body 101, where one of the pry ends 103 is defined rearwardly to the hammer section 102, where the pry ends 103 and 104 are configured to gradually remove a fastener 201 from one solid body or the combination of solid bodies 202.

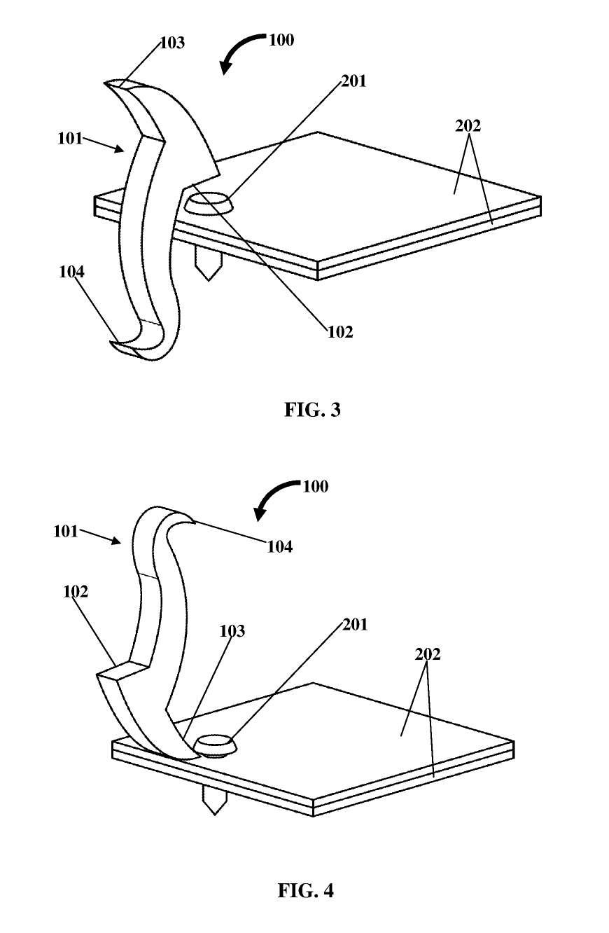

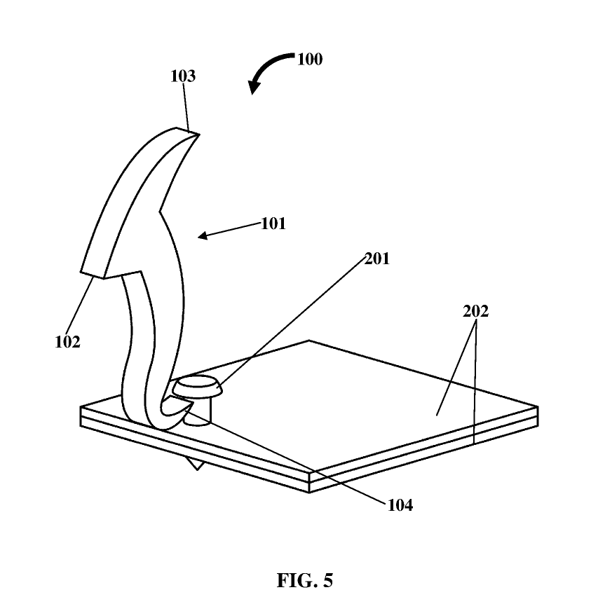

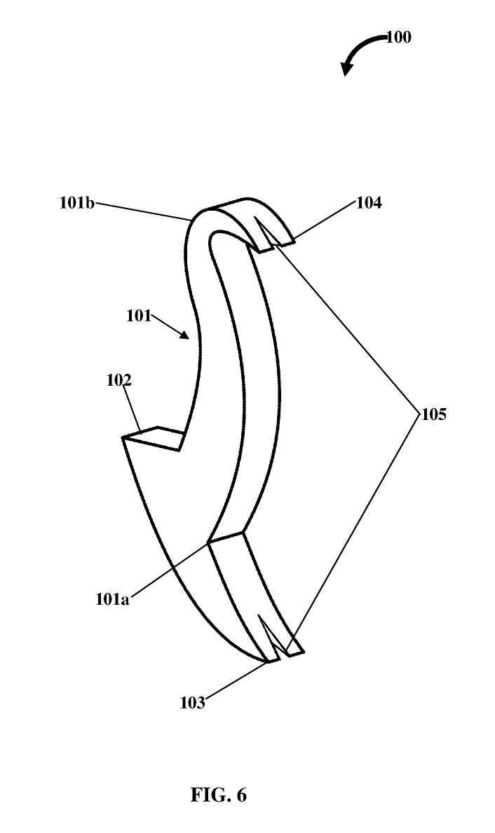

FIG. 3 exemplarily illustrates a bottom perspective view of the combined hammer and pryer apparatus 100, FIG. 4 exemplarily illustrates a perspective view of the combined hammer and pryer apparatus 100, showing the hammering action to fasten two solid bodies 202, and FIG. 5 exemplarily illustrates a perspective view of the combined hammer and pryer apparatus 100, showing prying initiation to remove the fastener 201 between two solid bodies 202. Referring to FIGS. 3-5, in an embodiment, the pry ends 103 and 104 comprise a pry initiation end 103 and a pry finishing end 104. The pry initiation end 103 is of a generally wedge shape and is defined at a first end 101a of the opposing ends 101a and 101b of the arcuate body 101 and rearwardly to the hammer section 102, where the pry initiation end 103 is configured to initiate a removal of the fastener inserted between the solid bodies 202. The user uses the pry initiation end 103 to initiate the removal of the fastener 201 where the fastener 201 is partially raised from the fastened condition. Now, the pry finishing end 104 is of a generally hook shape and is defined at a second end 101b of the opposing ends 101a and 101b of the arcuate body 101, where the pry finishing end 104 is configured to completely remove the fastener 201 from between the solid bodies 202, where the user engages the pry finishing end 104 underneath the partially removed fastener 201 as mentioned before, and completely removes the fastener 201 by applying leverage on the arcuate body 101. In an embodiment, the combined hammer and pryer apparatus 100 is made of a metal. In an embodiment, the combined hammer and pryer apparatus 100 is of multiple dimensions. In an embodiment, the combined hammer and pryer apparatus 100 is made of a metal.

FIG. 6 exemplarily illustrates a perspective view of an embodiment of the combined hammer and pry apparatus 100, showing V shaped grooves 105 positioned on the opposing pry ends 103 and 104. In an embodiment, the combined hammer and pryer apparatus 100 further comprises a generally V shaped groove 105 positioned on each of the pry ends 103 and 104 on the opposing ends 101a and 101b of the arcuate body 101, where the V shaped grooves 103 and 104 are configured to assist in gradually removing the fastener 201 from one of the solid body and the combination of solid bodies 202. The V shaped grooves 105 are designed to provide better grip around the fastener 201, which further provides additional stability while the fastener 201 is being pulled out of a solid body 202.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1. A combined hammer and pryer apparatus comprising:
an arcuate body;
a hammer section defined at a first end of opposing ends of the arcuate body, wherein the hammer section is configured to insert a fastener to one of a solid body and a combination of solid bodies; and
at least two pry ends defined on the opposing ends of the arcuate body, wherein one of the pry ends is defined rearwardly to the hammer section, wherein the pry ends are configured to gradually remove a fastener from one of a solid body and a combination of solid bodies.

2. The combined hammer and pryer apparatus of claim 1, wherein a first pry ends of the pry ends comprises a pry initiation end of a generally wedge shape defined at the first end of the opposing ends of the arcuate body and rearwardly to the hammer section, wherein the pry initiation end is configured to initiate a removal of the fastener inserted between the solid bodies.

3. The combined hammer and pryer apparatus of claim 1, wherein a second pry end of the pry ends comprises a pry finishing end of a generally hook shape defined at a second end of the opposing ends of the arcuate body, wherein the pry finishing end is configured to completely remove the fastener from between the solid bodies.

4. The combined hammer and pryer apparatus of claim 1, is made of a metal.

5. The combined hammer and pryer apparatus of claim 1, is of a plurality of dimensions.

6. The combined hammer and pryer apparatus of claim 1, wherein the fastener comprises one of a screw, a nail, and a bolt.

7. The combined hammer and pryer apparatus of claim 1, further comprising a generally V shaped groove positioned on each of the pry ends on the opposing ends of the arcuate body, wherein the V shaped grooves are configured to assist in gradually removing the fastener from one of the solid body and the combination of solid bodies.
